(19) United States
(12) Patent Application Publication
(10) Pub. No.: US 2024/0397121 A1
(43) Pub. Date: Nov. 28, 2024

(54) SYSTEM AND METHOD FOR MANAGING AND STREAMING LIVE EVENTS

(71) Applicant: Lane Lowery, Wichita, KS (US)

(72) Inventor: Lane Lowery, Wichita, KS (US)

(21) Appl. No.: 18/776,945

(22) Filed: Jul. 18, 2024

Related U.S. Application Data
(60) Provisional application No. 63/504,410, filed on May 25, 2023.

(51) Int. Cl. H04N 21/2187; G06F 16/738; G06F 16/783; H04N 21/234

(52) U.S. Cl. CPC H04N 21/2187; G06F 16/738; G06F 16/783; H04N 21/23424

(57) ABSTRACT

A system and method for managing and streaming a live event for viewing on a VR headset. The system allows a user to virtually and remotely watch a live event. Users can book a seat for an event through an interface on their devices. The system captures the event from the selected seat location using cameras and microphones. It can then live stream the event to the user's device, providing a realistic experience of watching the event from the chosen seat.

### CROSS-REFERENCE TO RELATED APPLICATIONS

This application claims priority from a U.S. Provisional Patent Appl. No. 63/504,410, filed on May 25, 2023, which is incorporated herein by reference in its entirety.

### FIELD OF INVENTION

The present invention relates to managing and streaming live events, and more particularly, the present invention relates to a system and method for managing and streaming live events on virtual reality headsets.

### BACKGROUND

Concerts, theaters, and other live events are extremely popular. Watching performers live is a unique experience compared to watching a recorded performance. Audiences tend to feel a connection with the performers during live shows. Typically, people need to buy tickets or passes to attend live events, and these can be bought in advance or on the spot. Ticket prices for popular shows can be high, making it difficult for fans to afford them. Moreover, events featuring celebrities can sell out far in advance, sometimes before fans even hear about them. Additionally, some events may be held at distant locations, making it challenging for fans to attend.

Thus, a need is appreciated for a system and method that can overcome the aforesaid problems and limitations.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for managing an event and live streaming the event for viewing on a virtual reality headset.

Another object of the present invention is that the system and method allow enjoying a live performance from any suitable location.

Still, another object of this invention is to make the cost of watching a live event affordable to many.

A further object of this invention is to offer a lifelike experience of attending a live performance remotely.

Yet another object of this invention is that enthusiasts can now enjoy watching their favorite celebrity perform live without the hassle of booking in advance.

In one aspect, disclosed is a method for managing and streaming an event live to a user device, the method implemented by a system comprising one or more processors, one or more memories, one or more cameras, and one or more microphones, wherein the method comprises receiving, a seat selection for the event by the system from the user device; capturing the event by the one or more cameras and one or more microphones from a position of the selected seat; encoding a feed from the one or more cameras and one or more microphones to a format suitable for streaming by the system; and streaming the encoded feed in near real-time by the system to the user device for displaying on a VR headset coupled to the user device. The method further comprises inserting advertisements in the live stream by the system for displaying on the VR headset, wherein the advertisement appears to be a part of the event. The system further comprises the VR headset. The method further comprises receiving one or more keywords through an interface implemented on the user device; querying one or more external servers by the system using the one or more keywords; downloading content related to the one or more keywords from the external servers; and presenting results on the user device, through the interface, by the system.

In one aspect, disclosed is a system for managing and streaming an event live to a user device, the system comprising one or more processors, one or more memory units, one or more cameras, and one or more microphones, wherein the system is configured to implement a method comprising receiving, a seat selection for the event by the system from the user device; capturing the event by the one or more cameras and one or more microphones from a position of the selected seat; encoding a feed from the one or more cameras and one or more microphones to a format suitable for streaming by the system; and streaming the encoded feed in near real-time by the system to the user device for displaying on a VR headset coupled to the user device. The method further comprises inserting advertisements in the live stream by the system for displaying on the VR headset, wherein the advertisement appears to be a part of the event. The system further comprises the VR headset. The method further comprises receiving one or more keywords through an interface implemented on the user device; querying one or more external servers by the system using the one or more keywords; downloading content related to the one or more keywords from the external servers; and presenting results on the user device, through the interface, by the system.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing an environment of the disclosed system, according to an exemplary embodiment of the present invention.

FIG. 2 shows an architecture of the disclosed system, according to an exemplary embodiment of the present invention.

FIG. 3 shows a screen of the interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Although operations may be described as a sequential process, some of the operations may in fact be performed in parallel, concurrently, and/or in a distributed environment, and with program code stored locally or remotely for access by single or multi-processor machines. In addition, in some embodiments, the order of operations may be rearranged without departing from the spirit of the disclosed subject matter.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion.

The described invention pertains to a system and method for managing a live event and streaming the live event for viewing on a VR headset. VR headsets are known in the art as a 3D near-eye display that can be mounted to a head and provides a virtual reality environment to the user. The users can watch a live event on a VR headset streamed live as if they are present in the event.

Thus, the disclosed system and method can make entertainment accessible to everyone, not just certain users, and depending on the event, promotional offers can also be available to save customers even more money.

In certain implementations, the disclosed system and method may allow anyone to buy a ticket to a present or future event directly through an interface provided by the system and be able to watch that event live via a VR display or a mobile device from anywhere in the world. The interface may also allow a person to search events based on multiple parameters, such as location, sports, artists, favorite teams, etc. A person upon booking can get a seat or position in the event virtually and remotely. The feed of a live event can be streamed by the system from a seat in the event as if the user is sitting on that seat and enjoying the live event. The surrounding environment of the seat can be implemented on the VR headset. Thus, the user gets the most realistic feeling of being in the stadium i.e., at the event, with the rest of the fans, virtually on the VR headset. The users can reserve the desired seats in the event, for example, the booking cost of certain seats can be higher than another set of seats based on the location of the set relative to the seat. Thus, a seat selection screen of the disclosed interface can be presented on the user device for selecting the seat.

In certain implementations, advertisements can also be displayed to a user watching a live event. Advertising products and services at events are common. The disclosed system can also present advertisements as if the user is in a live event and watching the advertisements. For example, a banner or poster can be displayed on a side wall of the hall in which the event is taking place. However, unlike static advertisements, the disclosed system and method can display dynamic advertisements, i.e., multiple advertisements can be shown interchangeably and economically.

In certain implementations, the tickets that the users purchase, according to the present invention, may also include event NFTs that the user can sell or trade as well as use towards a reward program that will allow the user to collect multiple NFTs and use them for promotional rewards such as free events, exclusive events, and so forth.

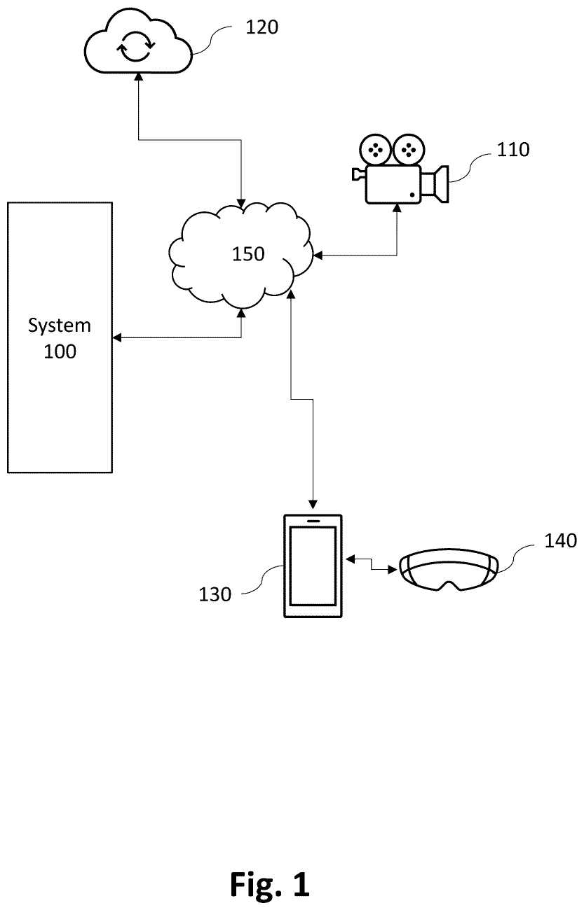

Referring to FIG. 1 a block diagram showing an environment of system 100. System 100 can connect to one or more audio-video sets 110. One or more audio-video sets can include a video camera and microphone. Live events can be captured by the audio-video sets and streamed to the user device in near real-time. These audio-video sets can be positioned on selected seats to capture the event and surroundings from the respective seats. Preferably, a person can operate the audio-video sets as if he is watching the event. The audio-video set can include suitable networking circuitry for transmitting the captured feed in near real time to the servers and/or user devices. For example, networking circuitry can include a transmitter and a receiver. The networking circuitry can connect to internet or any kind of network. Also, the networking circuitry may be capable of encrypting the feed for security. Also, secured lines, tunnels, or frequency can be used to prevent unauthorized access to the feed. The networking circuitry may include suitable portable modem for establishing secure and uninterrupted connection with servers and user devices.

In certain implementations, the audio-video sets may include one or more cameras and one or more microphones. The system and an audio-video set can be integral, such as a portable and standalone assembly can be positioned at a suitable position in an event. The assembly can capture the event and live stream the feed to the user devices.

In certain implementations, one or more audio-video sets can be worn like a helmet or headgear, over the head by a person. The person can normally watch the event while the audio-video set can capture the event, providing a realistic experience to the user. The disclosed system can receive live streams from one or more audio-video sets.

The system can also connect to external servers 120 through a network. The system can download information about various events, advertisement data, and the like from external servers. The system can provide an interface that allows the user to search for different events using their schedule and place. The system can get all such data from external servers. Moreover, the system can get daily updates about the events including promotional videos and like content. The system can present the same to the user based on the interest of the user. For example, the user has shown interest in an event and may also have booked the event in advance. The user can be presented with all the updates and promotional content of the event.

The system can also connect to one or more user devices. The user devices can be smartphones, desktop computers, laptops, tablets, and the like. The user device may also be connected to a VR headset 140. The system can live stream the event on the user device and display it on the VR headset. The user device can be a smartphone, a laptop computer, a tablet computer, a desktop, a smartwatch, and the like computing devices known in the art. The structure and functioning of the VR headsets are also known in art.

As shown in the drawings, the system can connect to different devices through a network 150. Also, the system can directly connect to a device and any such connection is within the scope of the present invention. The network can be wired, or wireless, or may include a combination of wired and wireless networks. Moreover, the network can be a secured network or an unsecured network. Examples of the networks include a local area network (LAN), a wide area network (WAN), a wireless WAN, a wireless LAN (WLAN), a metropolitan area network (MAN), a wireless MAN network, a cellular data network, a cellular voice network, and the Internet.

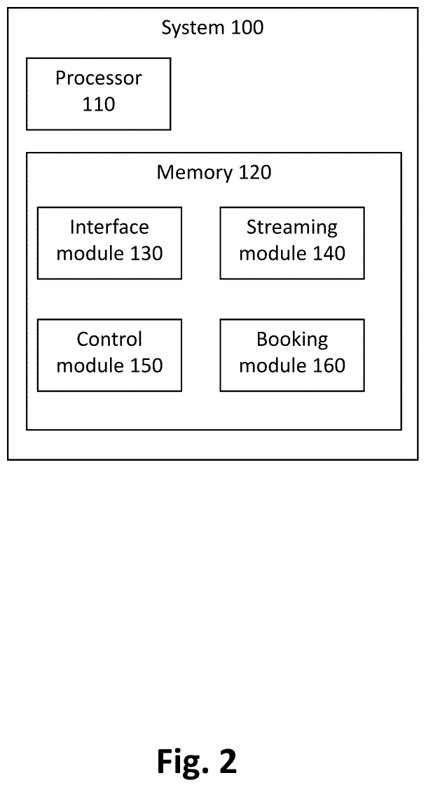

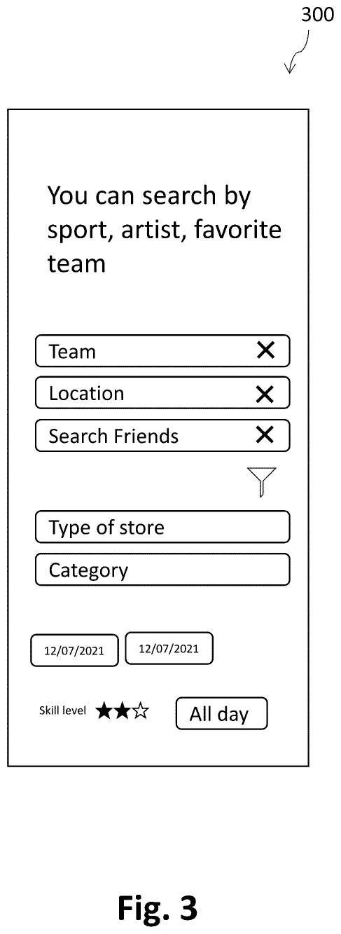

Referring to FIG. 2 is a block diagram showing the architecture of system 100. The system can include one or more processors 210 and a memory 220. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The memory includes an interface module 130, a streaming module 140, a control module 150, and a booking module 160. The interface module 130 upon execution by the processor 210 provides an interface on the user device 130, and through the interface, a user can interact with the disclosed system 100. The streaming module 140, upon execution by the processor 210, can provide a live stream of an event on the user's device. The control module 150, upon execution by the processor 210, can manage different aspects of the system 100. The booking module 160 upon execution by the processor 210 allows for searching for an event, booking the event, and providing updates about the event on the user device 130. FIG. 3 shows a screen 300 of the interface that allows a user to search for events. As shown in FIG. 3, the system can provide multiple options to search for an event and filter the same.

The interface can be provided as application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100 and information can be received by system 100 from the user.

The system can be implemented in the form of one or more servers, wherein the one or more servers include cloud servers. Also, one or more servers can be positioned at one location or geographically dispersed.

Users can first register themselves on the system by providing contact information, such as email addresses and phone number. The users can download the interface on their user device, which can be a smartphone or like computing device as explained above. Through the interface, a screen “create your account” can be presented to the user. The screen can include a form for receiving information from the user in an organized manner. The system can receive information like full name, email address, location, and password. The location information can be derived from a location service running on the user device. Alternatively, the user can manually enter the location information. Upon successful submission of the form by the user, the system can generate an account for the user, wherein the account can be linked to the user profile. The user can now access the login screen of the interface on their user device. The user can log in using their email address and password. It is to be understood that the login to the system can be secured and unsecured. In the case of secured login, login credentials like username and password can be used. Also, biometric-based login credentials are within the scope of the present invention.

Once the user successfully login, a home screen can be presented to the user, by the booking module. In the home screen, upcoming events can be displayed by the booking module. The booking module can receive the location through the profile and can display the events near the user's location on the home screen. Besides the location, other criteria, such as favorite celebrities, sports, music, and the like, information about the user can be collected by the booking module. The booking module can use all this information to filter the events and present the same on the home screen.

The home screen may also include a search field, which can receive keyword entries from the user. The booking module may receive keyword queries from the user and present the results. For example, the user can search for a sports event or a concert. The home screen may also include a podcast icon, that can open a new screen that allows the user to broadcast their podcast. For example, the user while watching a live event can also run a podcast on the event. The user can also run podcasts on past and future events. This may also help more people to join the disclosed platform.

A setting icon can also be displayed on the home screen, which opens another screen for allowing the user to change their preferences, profile, and account information. The user can also adjust the security settings of their account. The user can also be presented with a notification screen that provides any update to the user. For example, a notification that an event is about to start can be presented on the notification screen of the interface.

The booking module can also receive a selection of any event by the user. For example, the user may select an event on the home screen or in the search results. The booking module can then present the information of the event on an event screen of the interface. The event screen can display information about the event including its location, preview images, preview videos, timings, performers, and the like. The booking module can also provide an option to book an event through the event screen. For example, an icon can be displayed to receive a selection from the user. The booking module, upon receiving the selection can present a seat selection screen to the user. The user can make a selection by clicking on the booking icon. The user selection can be received by the booking module in any other way without departing from the scope of the present invention.

The seat selection screen can show a layout of the seating arrangement at the event and the available positions. The user can choose the desired position by clicking the same. Once a desired position in the event can be selected by the user, a confirmation screen can be shown to the user by the booking module. The confirmation screen can show the information about the event including the fee for the selected seat. The confirmation screen can also show any terms and conditions of attending the event virtually. Suitable help can also be provided to the user for viewing the event on their VR headset. The user can proceed to confirm the booking, and the booking module can send a confirmation to the user. In certain implementations, the booking module may require the user to pay a fee for confirming the position in the event. In such a case, a payment interface can be presented to the user. The payment interface may allow the user to pay through a variety of options including credit cards, debit cards, cryptocurrency, and the like. The user may also link their crypto wallets for faster payments.

Once the user registers for the event, the booking module can send any update about the event to the user through the user interface. The booking module can also send notifications and reminders that the event is about to start. When the event is started, the streaming module can broadcast the live stream of the event to the user device. The user can connect their VR headset and view the live event virtually and remotely from the location of the live event.

In certain implementations, the streaming module receives multiple streams for multiple audio-video sets positioned at different positions in the live event. The streaming module can also manipulate the stream such as inserting advertisements and making it more realistic. The streaming module can receive the seat selection of the user and stream the feed corresponding to the selected seat to the user.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for managing and streaming an event live to a user device, the method implemented by a system comprising one or more processors, one or more memories, one or more cameras, and one or more microphones, wherein the method comprises:
receiving, a seat selection for the event by the system from the user device;
capturing the event by the one or more cameras and one or more microphones from a position of the selected seat;
encoding a feed from the one or more cameras and one or more microphones to a format suitable for streaming by the system; and
streaming the encoded feed in near real-time by the system to the user device for displaying on a VR headset coupled to the user device.

2. The method of claim 1, wherein the method further comprises:
inserting advertisements in the live stream by the system for displaying on the VR headset, wherein the advertisement appears to be a part of the event.

3. The method of claim 1, wherein the system further comprises the VR headset.

4. The method of claim 1, wherein the method further comprises:
receiving one or more keywords through an interface implemented on the user device;
querying one or more external servers by the system using the one or more keywords;
downloading content related to the one or more keywords from the external servers; and
presenting results on the user device, through the interface, by the system.

5. A system for managing and streaming an event live to a user device, the system comprising:
one or more processors,
one or more memory units,
one or more cameras, and
one or more microphones,
wherein the system is configured to implement a method comprising:
receiving, a seat selection for the event by the system from the user device;
capturing the event by the one or more cameras and one or more microphones from a position of the selected seat;
encoding a feed from the one or more cameras and one or more microphones to a format suitable for streaming by the system; and
streaming the encoded feed in near real-time by the system to the user device for displaying on a VR headset coupled to the user device.

6. The system of claim 5, wherein the method further comprises:
inserting advertisements in the live stream by the system for displaying on the VR headset, wherein the advertisement appears to be a part of the event.

7. The system of claim 5, wherein the system further comprises the VR headset.

8. The system of claim 5, wherein the method further comprises:
receiving one or more keywords through an interface implemented on the user device;
querying one or more external servers by the system using the one or more keywords;
downloading content related to the one or more keywords from the external servers; and
presenting results on the user device, through the interface, by the system.
